(19) United States
(12) Patent Application Publication
(10) Pub. No.: US 2006/0275663 A1
(43) Pub. Date: Dec. 7, 2006

(54) Negative electrode active material and nonaqueous electrolyte secondary battery

(76) Inventors: Shinsuke Matsuno, Kashiwa-shi (JP); Tatsuoki Kono, Tokyo (JP); Norio Takami, Yokohama-shi (JP); Takao Sawa, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/432,402

(22) Filed: May 12, 2006

(30) Foreign Application Priority Data
May 16, 2005 (JP) 2005-143054
May 8, 2006 (JP) 2006-129465

(51) Int. Cl. H01M 4/58; C01B 33/00; C01B 31/20; C22C 28/00; C22C 13/00; C22C 12/00

(52) U.S. Cl. 429/218.1; 429/231.5; 429/224; 429/221; 429/223; 429/229; 423/324; 423/229; 420/557; 420/556; 420/576

(57) ABSTRACT

A negative electrode active material includes an intermetallic compound. The intermetallic compound has a long period order along each of at least two crystal axes. The intermetallic compound is represented by formula (1) given below:
LnM1_{y}M2_{z} (1)
where y and z fall within the ranges of 0.3≦y≦1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

### CROSS-REFERENCE TO RELATED APPLICATIONS

This application is based upon and claims the benefit of priority from prior Japanese Patent Applications No. 2005-143054, filed May 16, 2005; and No. 2006-129465, filed May 8, 2006, the entire contents of both of which are incorporated herein by reference.

### BACKGROUND OF THE INVENTION

1. Field of the Invention

The present invention relates to a negative electrode active material adapted for use in a nonaqueous electrolyte secondary battery and to a nonaqueous electrolyte secondary battery using the negative electrode active material.

2. Description of the Related Art

In recent years, a nonaqueous electrolyte secondary battery using a metal lithium as a negative electrode active material has attracted attention as a secondary battery having a high energy density. A primary battery using manganese oxide (MnO₂), a fluorocarbon [(CF₂)ₙ] or thionyl chloride (SOCl₂) as a positive electrode active material has already been used widely as a power source of a desktop computer or watch or as a back up battery of a memory. Further, in recent years, in accordance with miniaturization and decrease in weight of various electronic appliances such as a VTR and communication appliances, demands for use of a secondary battery having a high energy density is being enhanced. Such being the situation, vigorous research is being conducted on a lithium secondary battery using lithium as a negative electrode active material.

The lithium secondary battery that is being studied comprises a negative electrode containing metal lithium, a liquid nonaqueous electrolyte or a lithium conductive solid electrolyte, and a positive electrode containing as a positive electrode active material a compound performing a topochemical reaction with lithium. The liquid nonaqueous electrolyte known is prepared by dissolving a lithium salt such as LiClO₄, LiBF₄ or LiAsF₆ in a nonaqueous solvent such as propylene carbonate (PC), 1,2-dimethoxy ethane (DME), γ-butyrolactone (γ-BL) or tetrahydrofuran (THF). Also, the compound that is known to perform a topochemical reaction with lithium includes, for example, TiS₂, MoS₂, V₂O₅, V₆O₁₃ and MnO₂.

However, the lithium secondary battery described above has not yet been put to practical use. The main reason therefor is that the metal lithium used in the negative electrode is finely pulverized in the course of repeating the charge-discharge of the secondary battery, with the result that the metal lithium is converted into an active lithium dendrite so as to impair the safety of the battery and, in addition, to bring about the breakage, the short circuiting and the thermal runaway of the battery. The pulverization of the metal lithium brings about additional problems that the charge-discharge efficiency of the secondary battery is lowered by the deterioration of the lithium metal and that the charge-discharge cycle life of the secondary battery is shortened.

Under the circumstances, it is proposed to use a carbonaceous material that absorbs-releases lithium such as coke, a baked resin, a carbon fiber or pyrolytic vapor phase carbon in place of lithium. The lithium ion secondary battery that has been commercialized in recent years comprises a negative electrode containing a carbonaceous material, a positive electrode containing LiCoO₂ and a nonaqueous electrolyte. In such a lithium ion secondary battery, it is required to further improve the charge-discharge capacity per unit volume of the secondary battery in compliance with the demands for the further miniaturization and for the continuous operation of electronic appliances over a long time. Vigorous research is being conducted in an effort to satisfy the requirement. However, the particular requirement has not yet been satisfied sufficiently. It should be noted that it is necessary to develop a new negative electrode active material in order to realize a high capacity battery.

It has been proposed to use a single metal such as aluminum (Al), silicon (Si), germanium (Ge), tin (Sn) or antimony (Sb) as a negative electrode active material that permits obtaining a capacity higher than that obtained by a carbonaceous material. In particular, in the case of using Si as a negative electrode active material, it is possible to obtain such a high capacity as 4,200 mAh per unit weight (g). However, in the case of using a negative electrode formed of a single metal, the single metal is finely pulverized in the microscopic level in the course of repeating the absorption-release of Li, resulting in failure to obtain high charge-discharge cycle characteristics of the secondary battery.

In order to overcome the problems pointed out above, it has been attempted to improve the charge-discharge cycle life of the secondary battery by using as a negative electrode active material an alloy comprising an element T1 such as Ni, V, Ti or Cr that does not form an alloy with lithium and another element T2 that forms an alloy with lithium. Also, in order to suppress the fine pulverization of the electrode causing the deterioration of the charge-discharge cycle characteristics of the secondary battery, it is attempted to disperse in the electrode the phase active to lithium, e.g., the phase of element T2, and the phase inactive to lithium, e.g., the phase of element T1, in a nano scale for suppressing the volume expansion of the electrode. It is also attempted to make the entire alloy phase amorphous.

In any of the negative electrode active materials described above, an alloying reaction is carried out between the negative electrode active material and lithium so as to permit lithium to be absorbed in the negative electrode active material. Reaction formula (A) given below exemplifies the initial charging reaction:
T1ₓT2_{y}+Li→xT1+LiT2_{y} (A)

The second et seq. charge-discharge reactions after the initial charge-discharge reaction proceed as given by the reaction formula (B) given below:
xT1+LiT2_{y} [symbol] Li+yT2 (B)

Since the reaction given in reaction formula (B) is not completely reversible, Li is accumulated within the alloy, with the result that the amount of lithium supplied from the positive electrode into the negative electrode is decreased with progress in the charge-discharge cycle of the secondary battery. Finally, the secondary battery is made incapable of performing the charge-discharge cycle when lithium ceases to be supplied from the positive electrode into the negative electrode. Incidentally, in an amorphous alloy, the reaction proceeds smoothly in the initial stage. However, with increase in the number of charge-discharge cycles, crystallization of the alloy is promoted so as to cause deterioration of the charge-discharge cycle of the secondary battery.

It should also be noted that a negative electrode active material that performs an alloying reaction with lithium in the charging stage exhibits a high reactivity with a nonaqueous electrolyte containing a nonaqueous solvent such as ethylene carbonate, with the result that a film such as Li₂CO₃ is formed on the surface of the negative electrode by the reaction between lithium contained in the negative electrode active material and the nonaqueous electrolyte. Formation of the film noted above lowers the Coulomb efficiency of the negative electrode during the charge-discharge cycle. Further, if a Li-containing oxide such as LiCoO₂ is used as the positive electrode active material and Li contained in the positive electrode active material is used for the charge-discharge operation, Li in the positive electrode is depleted with progress in the charge-discharge cycle, with the result that the capacity deterioration is clearly observed.

In order to overcome the series of problems pointed out above, it is proposed to use a negative electrode active material having a La₃Co₂Sn₇ type crystal structure and a negative electrode active material having a CeNiSi₂ type crystal structure. It is known that lithium is intercalated inside the crystal structure of each of these negative electrode active materials. Since the change in volume of the lattice is small in the charging stage, the particular negative electrode active material exhibits excellent charge-discharge cycle characteristics. The particular negative electrode active materials pointed out above are disclosed in, for example, Jpn. Pat. Application KOKAI NO. 2000-311681, Jpn. Pat. Application KOKAI NO. 2004-79463, and Electrochemical and Solid State Letters, 8 (4) A234-A236 (2005).

However, in the nonaqueous electrolyte secondary battery using the intermetallic compound as a negative electrode active material, the intercalating rate of lithium inside the crystal structure is low so as to give rise to the problem that the charging time, particularly, the initial charging time, is long.

### BRIEF SUMMARY OF THE INVENTION

According to an embodiment of the present invention, there is provided a negative electrode active material containing an intermetallic compound having a long period order along each of at least two crystal axes and represented by formula (1) given below:
LnM1_{y}M2_{z} (1)

where y and z fall within the ranges of 0.3≦y≦1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

According to another embodiment of the present invention, there is provided a nonaqueous electrolyte secondary battery, comprising:

a positive electrode;

a negative electrode containing an intermetallic compound having a long period order along each of at least two crystal axes and represented by formula (1) given below; and

a nonaqueous electrolyte layer provided between the positive electrode and the negative electrode:
LnM1_{y}M2_{z} (1)
where y and z fall within the ranges of 0.3≦y≦1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

### BRIEF DESCRIPTION OF THE SEVERAL VIEWS OF THE DRAWING

FIG. 1A is a lamination model drawing schematically showing the La₃Co₂Sn₇ type crystal structure;

FIG. 1B is a lamination model drawing schematically showing the crystal structure having a long period order along each of two crystal axes;

FIG. 2 is a partial cross sectional view showing the construction of a cylindrical nonaqueous electrolyte secondary battery according to one embodiment of the nonaqueous electrolyte secondary battery of the present invention;

FIG. 3 is an oblique view, partly broken away, showing the construction of a flattened nonaqueous electrolyte secondary battery according to another embodiment of the nonaqueous electrolyte secondary battery of the present invention;

FIG. 4 is an electron beam diffraction diagram of the negative electrode active material for Example 1; and

FIG. 5 shows the X-ray diffraction pattern of the negative electrode active material under the four states of “before charge-discharge test”, “after charging”, “after discharge”, and “after second charging” of the nonaqueous electrolyte secondary battery for Example 1.

### DETAILED DESCRIPTION OF THE INVENTION

The negative electrode active material according to the embodiment of the present invention makes it possible to shorten the charging time of the secondary battery. According to the negative electrode active material, it is possible to provide a secondary battery excellent in discharge capacity per unit volume, in the charge-discharge cycle performance and in the initial charge-discharge efficiency. The negative electrode active material is adapted for use in a nonaqueous electrolyte secondary battery comprising a nonaqueous electrolyte layer and a positive electrode.

One embodiment of the nonaqueous electrolyte secondary battery of the present invention will now be described. The nonaqueous electrolyte secondary battery comprises a positive electrode, a negative electrode containing an intermetallic compound represented by the composition formula of LnM1_{y}M2_{z} and having a long period order along each of at least two crystal axes, and a nonaqueous electrolyte layer arranged between the positive electrode and the negative electrode.

The negative electrode, the positive electrode and the nonaqueous electrolyte layer included in the nonaqueous electrolyte secondary battery will now be described in detail.

1) Negative Electrode

(a) Long Period Order:

The negative electrode comprises a negative electrode active material containing an intermetallic compound represented by the composition formula of LnM1_{y}M2_{z} and having a long period order along each of at least two crystal axes. It has already been reported that the crystal structure of the intermetallic compound having the composition includes a La₃Co₂Sn₇ type crystal structure or a CeNiSi₂ type crystal structure. The intermetallic compound having the crystal structure has the charge-discharge reaction mechanism involving the lithium intercalation and, thus, makes it possible to realize a high discharge capacity and to exhibit stable charge-discharge cycle characteristics.

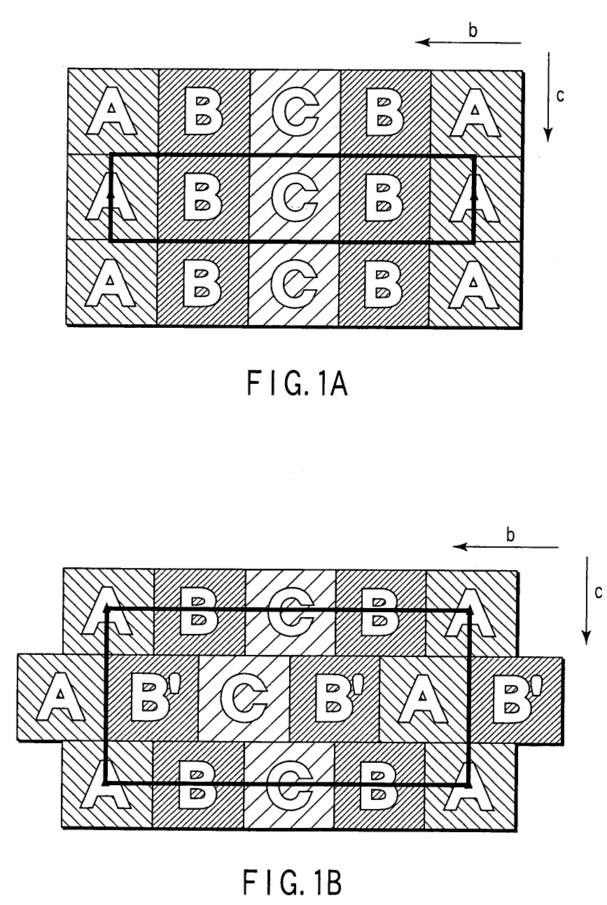

However, where the intermetallic compound has a long period order along each of at least two crystal axes, it is impossible to explain the crystal structure of the intermetallic compound with reference to the La₃Co₂Sn₇ type crystal structure and the CeNiSi₂ type crystal structure. If the La₃Co₂Sn₇ type crystal structure is explained by using a simple model, the crystal has a long period order of ABCBA in the direction of the b-axis as shown in FIG. 1A. On the other hand, a difference in the order also appears in the direction of the c-axis and, thus, a long period order (double period in this case) is also existed in the c-axis as shown in FIG. 1B. If a long period order is formed along each of at least two crystal axes in this fashion, the lithium diffusion rate inside the intermetallic compound is expected to be increased.

Each of units A, B, C shown in each of FIGS. 1A and 1B denotes any of the crystal structure and the composition and shows the crystal structure in this case. The construction having a long period order in the direction of the b-axis as shown in FIG. 1A can be said to have a super period structure in the direction of the b-axis. Also, in the intermetallic compound having a super period structure in the direction of the b-axis as shown in FIG. 1A, the region surrounded by an oblong line denotes a unit lattice.

The construction having a long period order along each of at least two crystal axes as shown in FIG. 1B can be said to have a super period structure along each of at least two crystal axes. In order to shorten the charging time, it is desirable for the intermetallic compound to have a super period structure in the directions of the b-axis and the c-axis. Where the intermetallic compound has a super period structure in the direction of the c-axis, it is desirable for the super period structure to be a super period structure of the double period. The construction of the super period structure of the double period is exemplified in FIG. 1B.

In the construction shown in FIG. 1B, the column of the units of the second stage is deviated by a half unit in the direction of the b-axis. In other words, the crystal structure is deviated with the composition left unchanged. To be more specific, the crystal structure of the unit B is slightly changed into the unit B′ with the crystal structure of each of units A and C left unchanged. It follows that since the column of the units is deviated every two units in the direction of the c-axis, the intermetallic compound can be said to have a super period structure of the double period in the direction of the c-axis. Where the intermetallic compound has a super period structure of the double period in the direction of the c-axis, the unit lattice is formed in the region surrounded by, for example, an oblong line.

(b) Composition of Negative Electrode Active Material:

The composition of the intermetallic compound having a long period order along each of at least two crystal axes can be represented by formula (1) given below:
LnM1_{y}M2_{z} (1)

where y and z fall within the ranges of 0.3≦y=1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

By using as Ln at least one element having an atomic radius in crystal in a range of 1.6×10⁻¹⁰ m to 2.2×10⁻¹⁰ m, the lithium ion can be inserted easily into the region between adjacent layers of the crystal. In the case of using as Ln the element having an atomic radius exceeding 2.2×10⁻¹⁰ m or smaller than 1.6×10⁻¹⁰ m, it is difficult to maintain the crystal structure having a long period order or it may be difficult to insert the lithium ion into the region between adjacent layers of the crystal.

It should be noted here that the atomic radius in crystal is defined as a value set forth in page 8 of “Metal Data Book, Revised 3rd Edition” edited by the Japan Institute of Metals, published by Maruzen Kabushiki Kaisha.

It is desirable for the element Ln to include, for example, La (atomic radius of 1.88×10⁻¹⁰ m), Ce (atomic radius of 1.83×10⁻¹⁰ m), Pr (atomic radius of 1.83×10⁻¹⁰ m), Nd (atomic radius of 1.82×10⁻¹⁰ m), Pm (atomic radius of 1.80×10⁻¹⁰ m), Sm (atomic radius of 1.79×10⁻¹⁰ m), Mg (atomic radius of 1.60×10⁻¹⁰ m), Ca (atomic radius of 1.97×10⁻¹⁰ m), Sr (atomic radius of 2.15×10⁻¹⁰ m), Ba (atomic radius of 2.18×10⁻¹⁰ m), Y (atomic radius of 1.82×10¹⁰ m), Zr (atomic radius of 1.62×10⁻¹⁰ m), and Hf (atomic radius of 1.60×10⁻¹⁰ m).

By allowing the alloy to contain the element M1 consisting of at least one element selected from the group consisting of Ti, V, Cr, Mn, Fe, Co, Ni, Cu, Zn and Nb, it is possible to stabilize the crystal structure having a long period order. It should be noted, however, that, if the atomic ratio y of the element M1 is smaller than 0.3 or larger than 1, it is possible for the crystal structure having a long period order not to be obtained. Such being the situation, it is desirable for the atomic ratio y to fall within a range of 0.3 to 1.

If the atomic ratio z of the element M2 is smaller than 2, it is possible for the ratio of the phase having a crystal structure other than the crystal structure having a long period order to be increased. On the other hand, if the atomic ratio z of the element M2 exceeds 3, the phase performing an alloying reaction with lithium, e.g., the LnSn phase, is formed in a large amount so as to shorten possibly the charge-discharge cycle life of the secondary battery. It is more desirable for the atomic ratio z to fall within a range of 2.2 to 2.8.

Incidentally, the ranges of 0.3≦y≦1 and 2≦z≦3 of the atomic ratios y and z in the formula of LnM1_{y}M2_{z} denotes the atomic ratio of Ln:M1:M2 of 1:0.3 to 1:2 to 3. In other words, the atomic ratio of M1 is 0.3 to 1 and the atomic ratio of M2 is 2 to 3 on the basis that the number of atoms of Ln is set at 1.

(c) Lattice Constant of Negative Electrode Active Material:

It is desirable for each of two crystal axes of the intermetallic compound to have a lattice constant of 8 Å or more. Also, it is desirable for the longest crystal axis of the intermetallic compound to have a lattice constant not smaller than 25 Å.

It is desirable for the a-axis or the c-axis of the intermetallic compound to have a lattice constant not smaller than 8 Å, more preferably not smaller than 8.5 Å. Where the lattice constant of the a-axis and the c-axis is smaller than 8 Å, the negative electrode may not constructed to be capable of the lithium intercalation even if the negative electrode has a long period crystal structure, with the result that the negative electrode may possibly be incapable of performing the function of a secondary battery. It is desirable for the upper limit of the lattice constant to be set at 10 Å. It should be noted that, if the lattice constant of the a-axis or the c-axis exceeds 10 Å, it is impossible to maintain the basic crystal structure, i.e., the crystal structure of La₃Ni₂Sn₇, with the result that the charge-discharge cycle characteristics of the secondary battery may possibly be lowered. Also, if the lattice constant of the longest axis is smaller than 25 Å, it is difficult to shorten the charging time. Such being the situation, it is desirable for the lattice constant of the longest axis of the crystal of the intermetallic compound to be not smaller than 25 Å. It is more desirable for the lattice constant of the longest axis to fall within a range of 25 to 33 Å. If the lattice constant of the longest axis exceeds 33 Å, it is difficult to maintain the basic crystal structure, i.e., the crystal structure of La₃Ni₂Sn₇, so as to possibly lower the charge-discharge cycle characteristics of the secondary battery.

(d) Size of Negative Electrode Active Material Crystallite:

It is desirable for the intermetallic compound to be formed of crystallites having an average crystal grain diameter not larger than 50 nm. Where the intermetallic compound has crystallites having the average crystal grain diameter exceeding 50 nm, the lithium diffusion rate is lowered so as to make it difficult to shorten the charging time.

(e) Manufacturing Method of Negative Electrode Active Material:

The manufacturing method of the negative electrode active material is not particularly limited. However, it is desirable to manufacture the negative electrode active material by the method described in the following.

In the first step, the powders of the elements are mixed in a manner to satisfy the chemical composition formula given previously and, then, the mixture is melted so as to prepare a melt of the raw materials (melting process). It is desirable for the melting process to be carried out by means of the high frequency melting.

In the next step, performed is a casting process in which the melt of the raw materials is rapidly cooled at a cooling rate not lower than 10³ K/s so as to solidify the melt. In the casting process, employed is a method in which a roll or a disk is used as a cooling body such as a super rapid solidification method, a single roll rapid solidification method, a double roll rapid solidification method, an atomizing method, a strip casting method, or a rapid solidification method such as a gas atomizing method. In the case of employing the solidification method, it is possible to obtain a cast body shaped like grains or a flake so as to facilitate the processing to a size adapted for use in a battery. Also, by increasing the solidification rate, it is possible to convert the crystal structure into a nano texture so as to make it possible to manufacture a negative electrode active material having a long period structure.

Also, after the casting process, the cast body is subjected to a heat treatment at 700 to 1100° C. for one minute to 10 hours in an inert gas atmosphere (heat treating process) so as to homogenize the texture and the composition, thereby obtaining a desired intermetallic compound (negative electrode active material).

It is also possible to perform a pulverizing process and a sieving process, as required, before or after the heat treating process.

(f) Manufacture of Negative Electrode

The negative electrode can be obtained by, for example, preparing a slurry by suspending a negative electrode mixture consisting of a negative electrode active material of a crystal structure having a long period order, a conductive agent and a binder in a suitable solvent, followed by coating one surface or both surfaces of a current collector with the slurry and subsequently drying the coating.

It is possible to increase the absorption amount of the alkali metal such as lithium by using as a negative electrode active material a mixture consisting of the negative electrode active material and a carbonaceous material having a high absorption capability of the alkali metal. It is desirable to use a graphitized carbon material as the carbonaceous material contained in the negative electrode active material. In this case, it is desirable to use, for example, a carbonaceous material such as acetylene black or carbon black as the conductive agent together with the graphitized carbon material because the conductivity is lowered in the case of using the graphitized carbon material alone having a high absorption capability of the alkali metal.

The binder includes, for example, polytetrafluoro ethylene (PTFE), polyvinylidene fluoride (PVdF), a fluorinated rubber, styrene-butadiene rubber (SBR) and carboxymethyl cellulose (CMC).

Concerning the mixing ratio of the negative electrode active material, the conductive agent and the binder, it is desirable for the negative electrode active material to be contained in the negative electrode in an amount of 70 to 95% by weight, for the conductive agent to be contained in the negative electrode in an amount of 0 to 25% by weight, and for the binder to be contained in the negative electrode in an amount of 2 to 10% by weight.

The current collector is not particularly limited as far as a conductive material is used for forming the current collector. For example, it is possible to use a foil, mesh, a punched metal or lath metal of copper, stainless steel or nickel.

2) Positive Electrode:

The positive electrode comprises a current collector and a positive electrode active material-containing layer formed on one surface or both surfaces of the current collector. The positive electrode can be prepared by, for example, suspending a positive electrode active material, a conductive agent and a binder in a suitable solvent, followed by coating the surface of a current collector such as an aluminum foil with the resultant suspension and subsequently drying and pressing the current collector coated with the suspension.

The positive electrode active material is not particularly limited as far as the material is capable of absorbing the alkali metal in the discharging stage of the secondary battery and is also capable of releasing the alkali metal in the charging stage of the secondary battery.

Various oxides and sulfides can be used as the positive electrode active material including, for example, manganese dioxide (MnO₂), lithium-manganese composite oxide. (e.g., LiMn₂O₄ or LiMnO₂), a lithium-nickel composite oxide (e.g., LiNiO₂), a lithium-cobalt composite oxide (e.g., LiCoO₂), a lithium-nickel-cobalt composite oxide (e.g., LiNi₁₋ₓCOₓO₂), a lithium-manganese-cobalt composite oxide (e.g., LiMnₓCo₁₋ₓO₂), and a vanadium oxide (e.g., V₂O₅). It is also possible to use as the positive electrode active material an organic material such as a conductive polymer material or a disulfide series polymer material.

It is more desirable to use a positive electrode active material, which permits increasing the battery voltage. The particular positive electrode active material, includes, for example, a lithium-manganese composite oxide (e.g., LiMn₂O₄), a lithium-nickel composite oxide (e.g., LiNiO₂), a lithium-cobalt composite oxide (e.g., LiCoO₂), a lithium-nickel-cobalt composite oxide (e.g., LiNi_{0.8}Co_{0.2}O₂), and a lithium-manganese-cobalt composite oxide (e.g., LiMnₓCo₁₋ₓO₂).

The current collector is not particularly limited as far as a conductive material is used for forming the current collector. However, when it comes to a current collector included in the positive electrode, it is desirable to use a material that is unlikely to be oxidized during the battery reaction. For example, it is desirable to use aluminum, stainless steel or titanium for forming the current collector for the positive electrode.

The conductive agent includes, for example, acetylene black, carbon black and graphite.

Further, the binder includes, for example, polytetrafluoro ethylene (PTFE), polyvinylidene fluoride (PVdF) and a fluorinated rubber.

Concerning the mixing ratio of the positive electrode active material, the conductive agent and the binder, it is desirable for the positive electrode active material to be contained in the positive electrode in an amount of 80 to 95% by weight, for the conductive agent to be contained in the positive electrode in an amount of 3 to 20% by weight and for the binder to be contained in the positive electrode in an amount of 2 to 7% by weight.

3) Nonaqueous Electrolyte Layer:

The nonaqueous electrolyte layer serves to impart an ionic conductivity between the positive electrode and the negative electrode.

It is possible for the nonaqueous electrolyte layer to be formed of a separator made of a porous material and holding a liquid nonaqueous electrolyte prepared by dissolving an electrolyte in a nonaqueous solvent.

The separator, which holds the liquid nonaqueous electrolyte, serves to achieve the insulation between the positive electrode and the negative electrode. The separator is not particularly limited as far as the separator is formed of an insulating material and is provided with pores that permit migration of the ions between the positive electrode and the negative electrode. To be more specific, it is possible for the separator to be formed of an unwoven fabric of a synthetic resin, a polyethylene porous film, and a polypropylene porous film.

It is possible to use a nonaqueous solvent formed of a cyclic carbonate such as ethylene carbonate (EC) or propylene carbonate (PC) or a nonaqueous solvent containing mainly a mixed solvent consisting of the cyclic carbonate and a solvent having a viscosity lower than that of the cyclic carbonate.

The nonaqueous solvent having a low viscosity noted above includes, for example, a linear carbonate (e.g., dimethyl carbonate, methyl ethyl carbonate or diethyl carbonate), γ-butyrolactone, acetonitrile, methyl propionate, ethyl propionate, a cyclic ether (e.g., tetrahydrofuran, or 2-methyl tetrahydrofuran), and a linear ether (e.g., dimethoxy ethane or diethoxy ethane).

A lithium salt is used as the electrolyte. To be more specific, it is desirable for the electrolyte to be formed of lithium hexafluoro phosphate (LiPF₆), lithium tetrafluoro borate (LiBF₄), lithium hexafluoro arsenate (LiAsF₆), lithium perchlorate (LiClO₄), or lithium trifluoro metasulfonate (LiCF₃SO₃). Particularly, it is desirable to use lithium hexafluoro phosphate (LiPF₆) and lithium tetrafluoro borate (LiBF₄) as the electrolyte.

It is desirable for the electrolyte to be dissolved in the nonaqueous solvent in a concentration of 0.5 to 2 mol/L.

Also, it is possible for the nonaqueous electrolyte layer to be formed of a gelled body prepared by mixing a polymer material and a liquid nonaqueous electrolyte. It is possible to arrange an electrolyte layer formed of a gelled body between the positive electrode and the negative electrode. It is also possible to arrange an electrolyte layer comprising a separator having a gelled body formed therein between the positive electrode and the negative electrode.

The polymer material used for preparing the gelled body includes a homopolymer such as polyacrylonitrile, polyacrylate, polyvinylidene fluoride (PVdF) or polyethylene oxide (PEO), and a copolymer containing acrylonitrile, acrylate, vinylidene fluoride or ethylene oxide as a monomer.

It is also possible for the nonaqueous electrolyte layer to be formed of a solid polymer electrolyte prepared by dissolving an electrolyte in a polymer material, followed by solidifying the resultant solution. The polymer material used for preparing the solid polymer electrolyte layer includes, for example, a homopolymer such as polyacrylonitrile, polyvinylidene fluoride (PVdF), and polyethylene oxide (PEO), and a copolymer containing acrylonitrile, vinylidene fluoride or ethylene oxide as a monomer. It is also possible to use an inorganic solid electrolyte as the nonaqueous electrolyte layer. The inorganic solid electrolyte noted above includes, for example, a ceramic material containing lithium such as Li₃N, Li₃PO₄—Li₂S—SiS₂, LiI—Li₂S—SiS₂ glass.

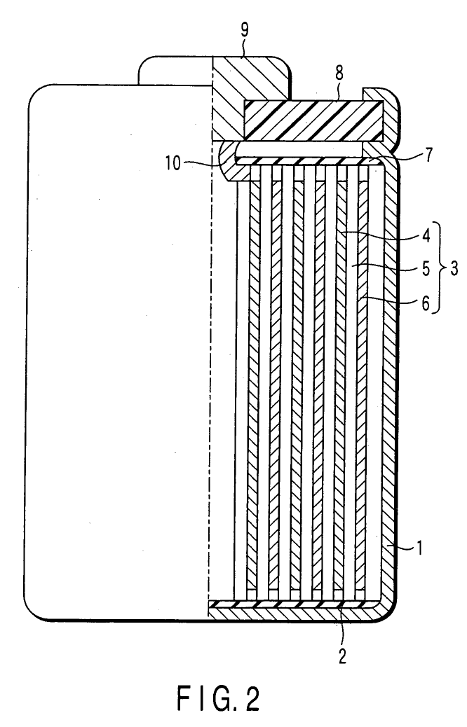

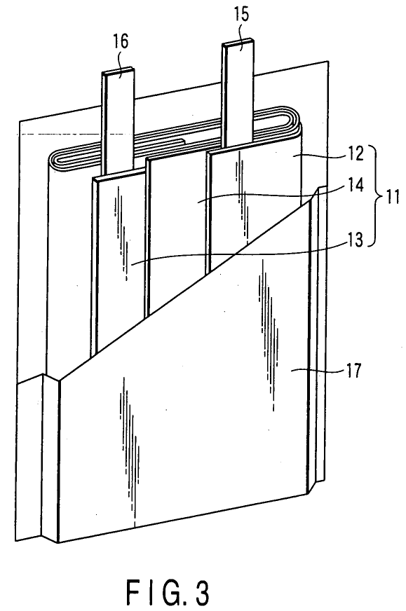

It is possible for the nonaqueous electrolyte secondary battery to be of various types such as a cylindrical type, a prismatic type, and a thin sheet type. FIG. 2 exemplifies the construction of a cylindrical nonaqueous electrolyte secondary battery and FIG. 3 exemplifies the construction of a thin sheet type (or flattened) nonaqueous electrolyte secondary battery.

As shown in FIG. 2, an insulating body 2 is arranged in the bottom portion of a cylindrical container 1 having a bottom and made of a stainless steel. An electrode group 3 is housed in the container 1. The electrode group 3 is manufactured by spirally winding a laminate structure consisting of a positive electrode 4, a negative electrode 6 and a separator 5 interposed between the positive electrode 4 and the negative electrode 6.

A liquid nonaqueous electrolyte is housed in the container 1. An insulating paper sheet 7 having an open section formed in the central portion is arranged within the container 1 so as to be positioned above the electrode group 3. An insulating sealing plate 8 is fixed by a caulking treatment to the upper open section of the container 1. A positive electrode terminal 9 is engaged with the central portion of the insulating sealing plate 8. A positive electrode lead 10 is connected to the positive electrode 4 at one end and to the positive-electrode terminal 9 at the other end. On the other hand, the negative electrode 6 is connected to the container 1 acting as a negative electrode terminal via a negative electrode lead (not shown).

FIG. 3 shows the construction of a shin sheet type nonaqueous electrolyte secondary battery. As shown in the drawing, an electrode group 11 comprises a positive electrode 12, a negative electrode 13 and a separator 14 interposed between the positive electrode 12 and the negative electrode 13 and has a flattened shape as a whole. A band-like positive electrode terminal 15 is electrically connected to the positive electrode 12. On the other hand, a band-like negative electrode terminal 16 is electrically connected to the negative electrode 13. The electrode group 11 is housed in a container 17 made of a laminate film such that the positive electrode terminal 15 and the negative electrode terminal 16 are allowed to protrude from within the container 17. The container 17 made of a laminate film is sealed by means of heat seal.

Incidentally, the shape of the electrode group housed in the container is not limited to the spiral shape as shown in FIG. 2 or to the flattened shape as shown in FIG. 3. It is also possible for the positive electrode, the separator and the negative electrode to be laminated a plurality of times one upon the other in the order mentioned.

Examples of the present invention will now be described in detail with reference to the accompanying drawings.

### EXAMPLES 1 TO 13

<Preparation of Positive Electrode>

A mixture was prepared by adding 2.5% by weight of acetylene black, 3% by weight of graphite, 3.5% by weight of polyvinylidene fluoride (PVdF) and a N-methyl pyrrolidone (NMP) solution to 91% by weight of a lithium-cobalt composite oxide (LiCoO₂) used as a positive electrode active material. Then, a current collector formed of an aluminum foil having a thickness of 15 μm was coated with the mixture thus obtained, followed by drying and, then, pressing the current collector coated with the positive electrode active material mixture so as to obtain a positive electrode having an electrode density of 3.0 g/cm³.

<Preparation of Negative Electrode>

Prescribed amounts of elements were mixed at the composition ratio shown in Table 1, followed by melting the mixture. Then, the melt thus obtained was subjected to a casting process by the double roll rapid solidification method under the cooling rate not lower than 10³ K/s. Further, the cast material was subjected to a heat treatment at 900° C. for 5 minutes under an inert gas atmosphere so as to obtain an intermetallic compound, thereby obtaining a negative electrode active material.

In the next step, 5% by weight of graphite used as a conductive agent, 3% by weight of acetylene black that was also used as a conductive agent, 7% by weight of PVdF and an NMP solution were added to and mixed with 85% by weight of the intermetallic compound, followed by coating a current collector formed of a copper foil having a thickness of 11 μm with the resultant mixture and subsequently drying and pressing the current collector coated with the mixture so as to obtain a negative electrode.

<Preparation of Electrode Group>

The positive electrode, a separator formed of a porous polyethylene film, the negative electrode, and an additional separator formed of a porous polyethylene film were laminated one upon the other in the order mentioned, followed by spirally winding the laminate structure such that the negative electrode was positioned to constitute the outermost circumferential layer, thereby obtaining an electrode group.

<Preparation of Liquid Nonaqueous Electrolyte>

Further, a liquid nonaqueous electrolyte was prepared by dissolving lithium hexafluoro phosphate (LiPF₆) in a mixed solvent consisting of ethylene carbonate (EC) and methyl ethyl carbonate (MEC), which were mixed at a mixing ratio by volume of 1:2. The electrolyte (LiPF₆) was dissolved in the mixed solvent in a concentration of 1 mol/L.

A cylindrical nonaqueous electrolyte secondary battery constructed as shown in FIG. 1 was assembled by allowing a cylindrical container made of stainless steel to house each of the electrode group and the liquid nonaqueous electrolyte noted above.

### EXAMPLE 14

An intermetallic compound was synthesized as in Example 6, except that the heat treatment was carried out at 950° C. for 10 minutes. Further, a cylindrical nonaqueous electrolyte secondary battery was assembled as in Example 1, except that used was the intermetallic compound thus obtained.

The intermetallic compound used in each of Examples 1 to 14 was analyzed by the X-ray diffraction method. The intermetallic compound for each of Examples 1 to 14 was found to have a long period order along each of at least two crystal axes and to have a composition of LnM1_{y}M2_{z} (0.3≦y≦1; 2≦z≦3).

### COMPARATIVE EXAMPLE 1

A cylindrical nonaqueous electrolyte secondary battery was manufactured as in Example 1, except that a Si powder having an average particle diameter of 10 μm was used as the negative electrode active material.

### COMPARATIVE EXAMPLE 2

A cylindrical nonaqueous electrolyte secondary battery was manufactured as in Example 1, except that the negative electrode active material used was formed of a mesophase pitch based carbon fiber subjected to a heat treatment at 3250° C. (the average fiber diameter of 10 μm, the average fiber length of 25 μm, the average layer spacing d₀₀₂ of 0.3355 nm, and the specific surface area as determined by the BET method of 3 m²/g).

### COMPARATIVE EXAMPLE 3

A cylindrical nonaqueous electrolyte secondary battery was manufactured as in Example 1, except that La₃Ni₂Sn₇ having a La₃Co₂Sn₇ type structure was used as the negative electrode active material.

### COMPARATIVE EXAMPLE 4

A cylindrical nonaqueous electrolyte secondary battery was manufactured as in Example 1, except that LaNi_{0.7}Sn₂ having a CeNiSi₂ type structure was used as the negative electrode active material.

(a) Example Relating to Confirmation of Crystal Structure:

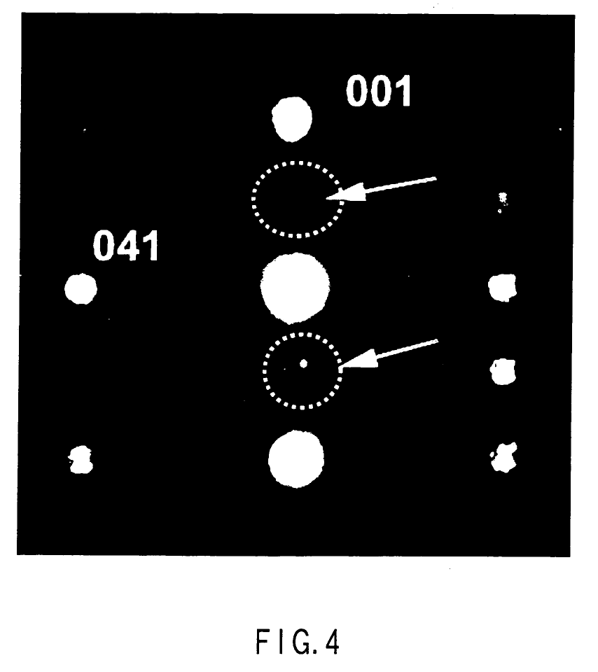

The long period structure was confirmed by TEM in respect of Example 1. FIG. 4 is a photo showing the electron beam diffraction.

When the intermetallic compound having the above-described composition was synthesized by rapid solidification, La₃Co₂Sn₇ type was observed. However, a spot that was not ascribed to the La₃Co₂Sn₇ type was observed in the portion denoted by an arrow (oblique arrow) in this Example. This indicates that a long period structure of the double period was observed in the direction of the c-axis. As shown in the photo of FIG. 4, a spot that was not ascribed to La₃Co₂Sn₇ type was observed at each space between diffraction spots ascribed to the (001) plane of the La₃Co₂Sn₇ structure. However, if a spot that is not ascribed to La₃Co₂Sn₇ type is observed at only one space between diffraction spots ascribed to the (001) plane of the La₃Co₂Sn₇ structure, it can be conclueded that the intermetallic compound has a long period structure of the double period in the direction of the c-axis.

A long period structure was confirmed in Examples 2 to 14, too, by the similar TEM observation. The crystallite size was confirmed to be not larger than 50 nm in Examples 1 to 13 by the similar TEM observation. Also, the lattice constant was measured by the X-ray diffraction so as to confirm that the lattice constant for each of the a-axis and the c-axis was not smaller than 8 Å and that the lattice constant for the b-axis was not smaller than 25 Å. Table 1 shows the lattice constant for each of the b-axis and the c-axis and the crystallite size.

(b) Example Relating to Charging Time:

Each of the manufactured secondary batteries was charged at 15° C. to 4.2 V under the charging current of 0.2 A. The charging was finished at the time when the current was lowered at 0.005 A. Table 1 shows the charging time, with the charging time for Comparative Example 3 set at 1.

TABLE 1

| | | Lattice | Lattice | | |
|---|---|---|---|---|---|
| | | constant | constant | | |
| | | of | of | Crystallite | Charging |
| | Composition of negative electrode | c-axis | b-axis | size | time |
| | active material | (Å) | (Å) | nm | Hr |
| Example 1 | LaNi_{0.6}Sn_{2.4} | 9.3 | 27.6 | 28 | 5.6 |
| Example 2 | LaNi_{0.3}Sn₂ | 8.9 | 26.3 | 39 | 5.9 |
| Example 3 | LaNi_{0.3}Sn₃ | 9.2 | 27.4 | 35 | 5.5 |
| Example 4 | LaNi_{1.0}Sn₂ | 9.4 | 28.0 | 31 | 6.1 |
| Example 5 | LaNi_{1.0}Sn₃ | 9.6 | 29.0 | 20 | 6.2 |
| Example 6 | (La_{0.7}Ca_{0.3})(Ni_{0.8}Co_{0.2})_{0.8}Sn_{2.2} | 8.7 | 28.5 | 39 | 5.9 |
| Example 7 | (Zr_{0.1}Ce_{0.9})(Ni_{0.7}Fe_{0.3})_{0.5}(Sn_{0.5}Ge_{0.5})_{2.5} | 8.3 | 29.2 | 47 | 5.5 |
| Example 8 | (La_{0.7}Ba_{0.1}Mg_{0.2})(Ni_{0.6}Cr_{0.05}Fe_{0.05} | 9.3 | 26.5 | 50 | 5.2 |
| | Co_{0.3})_{0.35}(Sn_{0.9}Si_{0.1})_{2.8} | | | | |
| Example 9 | (La_{0.6}Mg_{0.4})(Ni_{0.8}Ti_{0.2})_{0.87}(Sn_{0.8}P_{0.2})_{2.25} | 8.3 | 25.0 | 33 | 6.1 |
| Example 10 | La(Ni_{0.2}Ti_{0.6}V_{0.2})_{0.59}(Si_{0.9}Sb_{0.1})_{2.55} | 9.3 | 27.4 | 35 | 5.3 |
| Example 11 | Ce(Ni_{0.8}Cr_{0.05}Mn_{0.15})_{0.90}(Sn_{0.6}Bi_{0.4})_{2.4} | 8.0 | 25.3 | 25 | 5.2 |
| Example 12 | (Ce_{0.3}Sr_{0.7})(Ni_{0.6}Zn_{0.1}Nb_{0.3})_{0.35}Sn_{2.2} | 8.5 | 28.3 | 31 | 4.9 |
| Example 13 | La(Ni_{0.8}Cr_{0.2})_{1.0}(Sn_{0.6}Ge_{0.1}Bi_{0.3})_{2.3} | 9.3 | 27.3 | 20 | 5.3 |
| Example 14 | (La_{0.7}Ca_{0.3})(Ni_{0.8}Co_{0.2})_{0.8}Sn_{2.2} | 8.7 | 28.5 | 58 | 8.2 |
| Comparative | Si | — | — | — | 8.6 |
| Example 1 | | | | | |
| Comparative | C | — | — | — | 9.2 |
| Example 2 | | | | | |
| Comparative | La₃Ni₂Sn₇ | 4.6 | 27.7 | 171 | 12.5 |
| Example 3 | | | | | |
| Comparative | LaNi_{0.7}Sn₂ | 4.3 | 14.7 | 145 | 11.6 |
| Example 4 | | | | | |

As apparent from Table 1, where the intermetallic compound has a long period structure, the charging time can be shortened to about half or less of the charging time for Comparative Examples 3 and 4.

To be more specific, the charging time for the secondary battery for each of Examples 1 to 14 using an intermetallic compound having a super period structure in the directions of the b-axis and the c-axis can be made shorter than that of the secondary battery for each of Comparative Examples 1 to 4. Particularly, the charging time of the secondary battery for each of Examples 1 to 13 using an intermetallic compound having an average crystallite diameter not larger than 50 nm was made shorter than that of the secondary battery for Example 14 using an intermetallic compound having an average crystallite diameter exceeding 50 nm.

(c) Discharge Capacity and Charge-Discharge Cycle Characteristics:

Each of the manufactured secondary batteries was subjected to a charge-discharge cycle test, in which the secondary battery was charged at 15° C. to 4.2 V under the charging current of 0.2 A, and the charging was finished at the time when the current was lowered to 0.005 A, followed by discharging the secondary battery under the discharge current of 1 A until the battery voltage was lowered to 2.0 V. Measured were the discharge capacity per unit volume (mAh/cc) for the first cycle and the capacity retention ratio at the 150^{th} cycle (the discharge capacity for the first cycle being set at 100%). Table 2 shows the result. The composition formula given in Table 1 is also shown in Table 2.

TABLE 2

| | | Discharge | |
|---|---|---|---|
| | | capacity | Capacity |
| | | per unit | retention |
| | Composition of negative electrode | volume | ratio |
| | active material | (mAh/cc) | (%) |
| Example 1 | LaNi_{0.6}Sn_{2.4} | 1235 | 87 |
| Example 2 | LaNi_{0.3}Sn₂ | 1325 | 86 |
| Example 3 | LaNi_{0.3}Sn₃ | 1434 | 83 |
| Example 4 | LaNi_{1.0}Sn₂ | 1043 | 90 |
| Example 5 | LaNi_{1.0}Sn₃ | 1145 | 87 |
| Example 6 | (La_{0.7}Ca_{0.3})(Ni_{0.8}Co_{0.2})_{0.8}Sn_{2.2} | 1432 | 86 |
| Example 7 | (Zr_{0.1}Ce_{0.9})(Ni_{0.7}Fe_{0.3})_{0.5} | 1342 | 85 |
| | (Sn_{0.5}Ge_{0.5})_{2.5} | | |
| Example 8 | (La_{0.7}Ba_{0.1}Mg_{0.2})(Ni_{0.6}Cr_{0.05}Fe_{0.05} | 1254 | 83 |
| | Co_{0.3})_{0.35}(Sn_{0.9}Si_{0.01})_{2.8} | | |
| Example 9 | (La_{0.6}Mg_{0.4})(Ni_{0.8}Ti_{0.2})_{0.87} | 1353 | 87 |
| | (Sn_{0.8}P_{0.2})_{2.25} | | |
| Example 10 | La(Ni_{0.2}Ti_{0.6}V_{0.2})_{0.59}(Si_{0.9}Sb_{0.1})_{2.55} | 1352 | 88 |
| Example 11 | Ce(Ni_{0.8}Cr_{0.05}Mn_{0.15})_{0.90}(Sn_{0.6} | 1324 | 83 |
| | Bi_{0.4})_{2.4} | | |
| Example 12 | (Ce_{0.3}Sr_{0.7})(Ni_{0.6}Zn_{0.1}Nb_{0.3})_{0.35} | 1243 | 86 |
| | Sn_{2.2} | | |
| Example 13 | La(Ni_{0.8}Cr_{0.2})_{1.0}(Sn_{0.6}Ge_{0.1}Bi_{0.3})_{2.3} | 1323 | 87 |
| Example 14 | (La_{0.7}Ca_{0.3})(Ni_{0.8}Co_{0.2})_{0.8}Sn_{2.2} | 1253 | 92 |
| Comparative | Si | 9800 | 21 |
| Example 1 | | | |
| Comparative | C | 498 | 97 |
| Example 2 | | | |
| Comparative | La₃Ni₂Sn₇ | 1023 | 84 |
| Example 3 | | | |
| Comparative | LaNi_{0.7}Sn₂ | 964 | 81 |
| Example 4 | | | |

As apparent from Table 2, the secondary battery for each of Examples 1 to 14 exhibited a discharge capacity per unit volume, which was higher than that of the secondary battery for Comparative Example 2 using a carbonaceous material as the negative electrode active material, and also exhibited a capacity retention ratio at the 150^{th} cycle, which was higher than that for Comparative Example 1.

The comparison between Examples 2 and 3 and between Examples 4 and 5 indicates that the capacity retention ratio of the secondary battery at the 150^{th} cycle can be improved by the decrease in the number z of the M2 atoms and that the discharge capacity of the secondary battery per unit volume can be increased by the increase in the number z of the M2 atoms. On the other hand, the comparison between Examples 2 and 4 and between Examples 3 and 5 indicates that the discharge capacity per unit volume of the secondary battery can be increased by the decrease in the number y of the M1 atoms and that the capacity retention ratio of the secondary battery at the 150^{th} cycle can be improved by the increase in the number y of the M1 atoms.

The secondary battery for Example 14 using an intermetallic compound having an average crystal grain diameter exceeding 50 nm was found to exhibit the capacity retention ratio at the 150^{th} cycle, which was higher than that of the secondary battery for Example 6 using an intermetallic compound having an average crystal grain diameter not larger than 50 nm. However, in order to shorten sufficiently the charging time while retaining the discharge capacity per unit volume and the charge-discharge cycle characteristics of the secondary battery, it is desirable for the average crystal grain diameter to be not larger than 50 nm.

On the other hand, the secondary battery for Comparative Example 1 using Si as the negative electrode active material was found to be markedly inferior to the secondary battery for each of Examples 1 to 14 in the capacity retention ratio at the 150^{th} cycle of the charge-discharge operation. The discharge capacity per unit volume of the secondary battery for Comparative Example 2 using a carbonaceous material as the negative electrode active material was found to be markedly smaller than that of the secondary battery for Examples 1 to 14. Also, the secondary battery for each of Comparative Example 3 using an intermetallic compound having a super period structure on the b-axis alone and Comparative Example 4 using an intermetallic compound of the CeNiSi₂ type was found to necessitate a charging time longer than that for the secondary battery for each of Examples 1 to 14 and to exhibit a discharge capacity per unit volume smaller than that of the secondary battery for each of Examples 1 to 14.

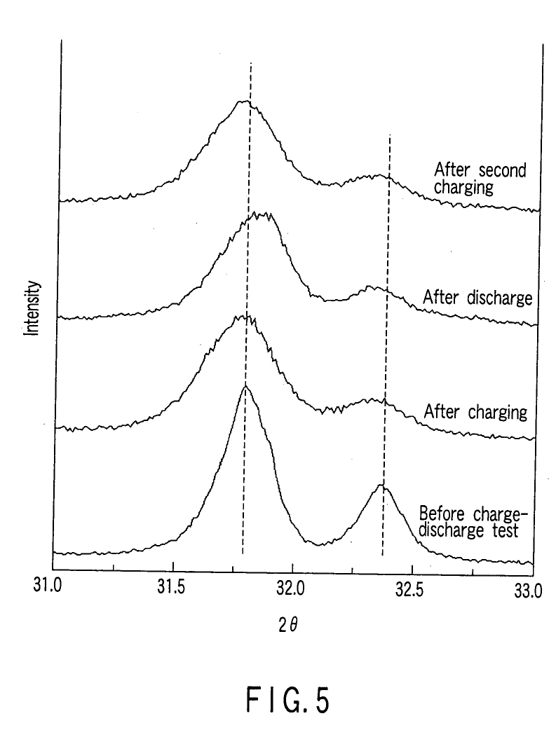

In order to examine the charging mechanism of the negative electrode active material for the Examples of the present invention, an X-ray diffraction measurement was performed both before and after the charge-discharge of the negative electrode. FIG. 5 is a diffraction pattern showing a part of the experimental data.

As shown in the diffraction pattern, the peak is reversibly changed, which indicates that the charge-discharge is based on the mechanism of the lithium insertion.

To be more specific, the peaks appearing around 31.75° and around 32.5° were broadly changed because the crystallinity was lowered by the charging. However, the micro-structure of the negative electrode active material did not become amorphous. The peaks were shifted back to the original positions respectively by the discharge. The positions of the peaks that were caused to appear around 31.75° and around 32.5° by the second charging were brought back to the state after the first charging. It follows that the peak was reversibly changed, supporting that the charge-discharge is based on the mechanism of the lithium insertion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A negative electrode active material containing an intermetallic compound having a long period order along each of at least two crystal axes and represented by formula (1) given below:
LnM1_{y}M2_{z} (1)
where y and z fall within the ranges of 0.3≦y≦1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

2. The negative electrode active material according to claim 1, wherein Ln denotes at least one element selected from the group consisting of La, Ce, Pr, Nd, Pm, Sm, Mg, Ca, Sr, Ba, Y, Zr and Hf.

3. The negative electrode active material according to claim 1, wherein M2 denotes Sn or the combination of Sn and at least one element selected from the group consisting of P, Si, Ge and Sb.

4. The negative electrode active material according to claim 1, wherein the intermetallic compound has two crystal axes each having a lattice constant not smaller than 8 Å.

5. The negative electrode active material according to claim 1, wherein the intermetallic compound has two crystal axes each having a lattice constant falling within a range of 8 to 10 Å.

6. The negative electrode active material according to claim 1, wherein the intermetallic compound has a longest crystal axis having a lattice constant not smaller than 25 Å.

7. The negative electrode active material according to claim 1, wherein the intermetallic compound has a longest crystal axis having a lattice constant falling within a range of 25 to 33 Å.

8. The negative electrode active material according to claim 1, wherein the intermetallic compound has a polycrystalline structure having an average crystal grain diameter not larger than 50 nm.

9. The negative electrode active material according to claim 1, wherein said at least two crystal axes is formed of a b-crystal axis and a c-crystal axis.

10. The negative electrode active material according to claim 1, wherein the intermetallic compound has a super period structure of the double period on a c-crystal axis.

11. A nonaqueous electrolyte secondary battery, comprising:
a positive electrode;
a negative electrode containing an intermetallic compound having a long period order along each of at least two crystal axes and represented by formula (1) given below; and
a nonaqueous electrolyte layer provided between the positive electrode and the negative electrode:
LnM1_{y}M2_{z} (1)
where y and z fall within the ranges of 0.3≦y≦1 and 2≦z≦3, respectively, Ln denotes at least one element having an atomic radius in crystal in a range of 1.6×10⁻¹⁰ to 2.2×10⁻¹⁰ m, M1 denotes at least one element selected from the group consisting of Ti, V, Cr, Mn, Fe, Co, Ni, Cu, Zn and Nb, and M2 denotes at least one element selected from the group consisting of P, Si, Ge, Sn and Sb.

12. The nonaqueous electrolyte secondary battery according to claim 11, wherein Ln denotes at least one element selected from the group consisting of La, Ce, Pr, Nd, Pm, Sm, Mg, Ca, Sr, Ba, Y, Zr and Hf.

13. The nonaqueous electrolyte secondary battery according to claim 11, wherein M2 denotes Sn or a combination of Sn and at least one element selected from the group consisting of P, Si, Ge and Sb.

14. The nonaqueous electrolyte secondary battery according to claim 11, wherein the intermetallic compound has two crystal axes each having a lattice constant not smaller than 8 Å.

15. The nonaqueous electrolyte secondary battery according to claim 11, wherein the intermetallic compound has two crystal axes each having a lattice constant falling within a range of 8 to 10 Å.

16. The nonaqueous electrolyte secondary battery according to claim 11, wherein the intermetallic compound has a longest crystal axis having a lattice constant not smaller than 25 Å.

17. The nonaqueous electrolyte secondary battery according to claim 11, wherein the intermetallic compound has a longest crystal axis having a lattice constant falling within a range of 25 to 33 Å.

18. The nonaqueous electrolyte secondary battery according to claim 11, wherein the intermetallic compound has a polycrystalline structure having an average crystal grain diameter not larger than 50 nm.

19. The nonaqueous electrolyte secondary battery according to claim 11, wherein said at least two crystal axes is formed of a b-crystal axis and a c-crystal axis.

20. The nonaqueous electrolyte secondary battery according to claim 11, wherein the intermetallic compound has a super period structure of the double period on a c-crystal axis.
